(19) United States
(12) Patent Application Publication
(10) Pub. No.: US 2007/0110177 A1
(43) Pub. Date: May 17, 2007

(54) RF power distribution in the frequency domain

(75) Inventors: Mats Molander, Sollentuna (SE); Karl Gosta Sahlman, Sollentuna (SE); Ulf Skarby, Lidingo (SE)

Correspondence Address: NIXON & VANDERHYE, PC, 901 NORTH GLEBE ROAD, 11TH FLOOR, ARLINGTON, VA, 22203, US

(73) Assignee: Telefonaktiebolaget LM Ericsson, Stockholm (SE)

(21) Appl. No.: 11/594,252

(22) Filed: Nov. 8, 2006

Related U.S. Application Data
(60) Provisional application No. 60/735,834, filed on Nov. 14, 2005.

(51) Int. Cl. H04K 1/10

(52) U.S. Cl. 375/260

(57) ABSTRACT

Data is transmitted during a transmission time interval using an available frequency bandwidth. Blocks of data to be transmitted at different power levels are identified. Multiple portions of the data blocks are distributed for transmission at different frequencies so that data blocks with higher power levels are distributed more toward the center of the determined frequency bandwidth than data blocks with lower power levels. The distributing of data block portions reduces the power of intermodulation products occurring outside the determined frequency bandwidth caused by radio frequency signals carrying the distributed data block portions fed through a non-linear power amplifier. It also reduces peaks in the power of the intermodulation products.

### CROSS-REFERENCES TO RELATED APPLICATIONS

This application claims domestic priority from provisional application Ser. No 60/735,834, filed Nov. 14, 2005, the disclosure of which is incorporated herein by reference. This application is related to commonly-assigned U.S. patent application Ser. No. 11/______, entitled “Peak-to-Average Power Reduction,” filed on Nov. ______, 2006 (atty. ref. 2380-1011).

### TECHNICAL FIELD

The technical field relates to radio communications. The technology described relates to radio frequency (RF) power distribution over frequency in a radio transmitter.

### BACKGROUND

Communication systems, whether they are used for transmitting analog or digital data, typically employ power amplifiers as part of the signal transmitter. For example, such power amplifiers are used in radio base station transmitters. Unfortunately, such power amplifiers have non-linear transfer functions. If plotted, the power amplifier's output signal amplitude and phase as a function of the power amplifier's input amplitude would present non-linear curves over a considerable range of the input signal amplitude. For a strong signal with varying amplitude, passing through the power amplifier, the non-linear transfer function causes distortion. When two or more strong signals simultaneously suffer the non-linear transfer function, intermodulation (IM) distortion occurs, which is a significant problem.

When employing Orthogonal Frequency Division Multiplexing (OFDM), amplitude variations occur in the time domain because a large number of subcarriers, all with different frequencies and with varying phase positions, are added together to obtain the modulated signal. The interference between these subcarriers, regardless of their modulation schemes, causes peaks and troughs in the time domain of the amplitude of the modulated signal. Also in this case the non-linearities of the power amplifier is a problem.

One brute force approach for reducing the effects of such distortions is to reduce the drive level into the amplifier (“backing off”) so that the amplifier output power is considerably below saturation, where the magnitudes of the AM/AM, AM/PM, and IM distortions are tolerable. But this technique is not an option if the amplifier has to be backed off considerably in order to obtain acceptable distortion levels. Backing off the power amplifier tends to reduce the power conversion efficiency of the power amplifier. Additionally, for a given required transmitter output power, a power amplifier operated at a lower efficiency must be larger (and more expensive) than a power amplifier that can be operated at peak efficiency. Also, for a given output power, a lower-efficiency power amplifier requires a more costly power supply and cooling arrangement.

An alternative approach to deal with such distortions is to use linearizing circuitry, in which the linearizing can be accomplished by, e.g., predistortion, Cartesian feedback, feed forward, or any other linearizing principle. For instance, predistortion circuitry operates on a modulated signal to be amplified by distorting the modulated signal with a calculated inverse of the transfer function of the power amplifier. Both the amplitude and phase transfer functions can be predistorted. Thus, ideally, the predistortion and the power amplifier distortion cancel each other out in the hope of obtaining linear amplification between the input of the linearizing unit and the output of the RF power amplifier.

In some cellular radio network standards, a radio base station may instantaneously transmit individual data to several mobile radio stations, sometimes referred to as User Equipments (UEs), using OFDM or similar modulation techniques within the available bandwidth allocated in the frequency domain to the radio base station for transmission in a cell area.

In OFDM, that available bandwidth is split onto a large number of equi-distant frequency subcarriers, and time is split into equally-sized symbols. FIG. 1 illustrates how the subcarriers and symbols may be organized into OFDM data “chunks,” where each OFDM data chunk comprises a certain number of successive subcarriers, and each subcarrier is modulated by a certain number of successive symbols. Different chunks may in principle contain different numbers of subcarriers. However, the chunk concept is primarily introduced in order to limit the amount of real-time processing capacity needed for scheduling. It may thus be practical to let all chunks contain the same, but not too small number of subcarriers. In a non-limiting example, a frequency band of 20 MHz may include an available bandwidth of 19.2 MHz, split into 1280 subcarriers 15 kHz apart, and guardbands of 2×0.4 MHz. In this case, each OFDM data chunk could include 20 subcarriers, and each subcarrier could be modulated by 7 symbols. Each symbol could last for approximately 71.4 μsec. Thus, each OFDM data chunk spans 300 kHz by 0.5 msec.

The radio base station dynamically schedules OFDM data chunks for instantaneous transmission to several UEs. In the frequency domain, several chunks may be allocated to each UE, even with different power levels. Since the signal to the power amplifier is a sum of all the different subcarriers transmitted, the peak-to-average power ratio (PAPR) is high.

During each OFDM transmission time interval, the radio base station uses an appropriate number of OFDM chunks for transmission to each UE that depends on the amount of data to transmit, the required quality of service, etc. FIG. 2 illustrates the manner in which contiguous OFDM chunks in the frequency dimension may be allocated to each of three UEs. The path loss between a radio base station transmitter and a UE's receiver may differ significantly between different simultaneous UEs due to differences in distance, path reflections, Rayleigh fading, etc. In order to reduce unnecessary interference and to maximize the utilization of the available output power, the radio base station transmitter sets the individual output power for each UE as low as possible while still compensating for the corresponding path loss and maintaining the signal-to-noise ratio needed for the intended type of data transfer. This causes the transmitting power level to vary substantially over frequency. The more uneven the power variation is over the available bandwidth, especially with higher power levels toward the outer parts of the bandwidth, the more peaks occur in the IM distortion spectrum. The output power level variation is illustrated in FIG. 2. All of the multiple chunks for UE 1 are shown grouped together as a block in the frequency domain and transmitted at a first high power; all of the multiple chunks for UE2 are grouped together as a block in the frequency domain and transmitted at a second low power; and all of the multiple chunks for UE3 are grouped together as a block in the frequency domain and transmitted at a third intermediate power.

Radio transmitters in general often have to fulfill requirements on out-of-band emissions to prevent the transmitter from interfering with other transmitters transmitting in adjacent channels. Typically, such requirements relate to the first and second adjacent channels. Fulfilling these requirements in the presence of high IM distortion in the power amplifier places high demands on the linearizing function. FIG. 3 illustrates an output spectrum of a non-compensated power amplifier plotted with an input signal following the power distribution of the UE chunks shown in FIG. 2. The graphed spectrum shows 3^{rd} and 5^{th} order intermodulation (IM) distortion peaks at a distance from the carrier of about 25 MHz and 42 MHz, respectively. These peaks violate out-of-band emissions requirements. In order to counteract any IM products that would otherwise violate the out-of-band emissions requirements, the linearizing function must both have a bandwidth that is wide enough to include any violating IM products and must, at the same time, have sufficient IM suppression capability at the frequencies where these violations may occur. In the case shown in FIG. 3, extra IM suppression capability is required at several places in the frequency domain in order to fulfill the out-of-band emissions requirements. Both these linearizing function requirements have significant cost.

### SUMMARY

The inventors realized that these problems could be solved by distributing in the frequency domain the RF power required to transmit a signal. A transmitter transmits data using a determined frequency bandwidth during a transmission time interval. Processing circuitry in the transmitter identifies one or more blocks of data to be transmitted during the transmission time interval, each block at its own power level. The data blocks may or may not exhaust the determined bandwidth. Multiple portions of the data blocks are distributed for transmission at different frequencies so that transmissions at higher power levels occur more in the center of the determined bandwidth than transmissions at lower power levels. A power amplifier amplifies a radio frequency signal carrying the distributed data block portions, and an antenna transmits the amplified signal. The distributing of the data block portion reduces the bandwidth required by the linearizing function for counter-acting the intermodulation products caused by the non-linearities in the power amplifier. The distributing also reduces the peak power of the intermodulation products.

Although the RF power distribution may include any type of spreading out of portions of the data blocks over frequency, one example distribution is to substantially concentrate higher power levels more towards the middle of the determined frequency bandwidth than lower power levels. Each data block may be associated with one or more intended receivers, and each intended receiver may be associated with one or more data blocks. The data blocks may be of the same size or of different sizes. Another less preferred distribution is to evenly distribute multiple portions of each of the data blocks across the determined frequency bandwidth.

The RF power distribution technology has application to any transmitter. As non-limiting examples, the technology may be used in the transmitter of a radio base station, of a wireless network access point, of a mobile radio station, or of a wirebound communications node. The transmitter may, in one non-limiting example, use OFDM. In that case, the data blocks include one or more OFDM data chunks, and each OFDM data chunk comprises one or more subcarriers and one or more data symbols. The subcarriers may or may not use the same modulating scheme. In the preferred example embodiment, multiple chunks of the data blocks are distributed for transmission at different frequencies so that transmissions at each of the different power levels are distributed with higher power levels more towards the center of the determined frequency bandwidth than lower power levels. In a less preferred example embodiment, multiple chunks of the data blocks are distributed for transmission evenly over the determined frequency bandwidth.

### BRIEF DESCRIPTION OF THE DRAWINGS

FIG. 1 illustrates the principle of OFDM mapping of subcarriers and symbols onto OFDM chunks;

FIG. 2 is a graph of the power level allocated by user over the available bandwidth;

FIG. 3 is a graph of the resulting actual RF output power distribution over frequency showing where attenuation requirements have not been met within the transmission bandwidth;

FIG. 4 is a function block diagram illustrating a non-limiting example of a transmitter that may be used to distribute transmission power over the determined bandwidth;

FIG. 5 is a flow chart diagram illustrating non-limiting, example procedures that may be used to implement RF power distribution over frequency;

FIG. 6 is a graph of the power level for several users distributed with higher power levels more towards the center of the determined frequency bandwidth than lower power levels;

FIG. 7 is a graph of the resulting actual RF output power distribution over frequency showing where attenuation requirements have been met within a certain linearizing bandwidth;

FIG. 8 is a function block diagram illustrating a non-limiting example application of the transmitter technology to a radio base station or access point transmitter;

FIG. 9 is a function block diagram illustrating a non-limiting example of an OFDM type transmitter that may be used in the non-limiting example application of FIG. 8; and

FIG. 10 is a flow chart diagram illustrating non-limiting, example procedures that may be used to implement OFDM power distribution over frequency.

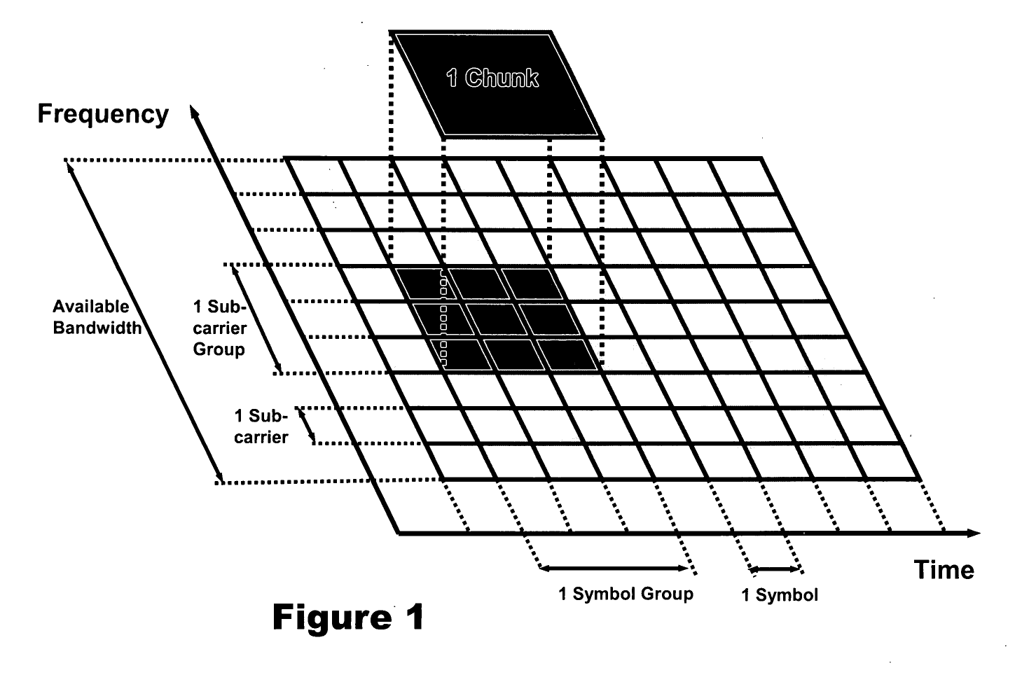

### DETAILED DESCRIPTION

The following description sets forth specific details, such as particular embodiments, procedures, techniques, etc. for purposes of explanation and not limitation. But it will be appreciated by one skilled in the art that other embodiments may be employed apart from these specific details. For example, although the following description is facilitated using non-limiting example applications to various OFDM transmitters, such as the non-limiting examples of transmitters for Wimax, the technology may also be employed for any type of wireless transmitters, such as the non-limiting examples of transmitters for GSM and TDMA, and any type of wirebound transmitters, such as the non-limiting examples of transmitters for ADSL. In some instances, detailed descriptions of well known methods, interfaces, circuits, and devices are omitted so as not to obscure the description with unnecessary detail. Moreover, individual blocks are shown in some of the figures. But multiple functions may be performed by one or more entities. Those skilled in the art will appreciate that the functions of those blocks may be implemented using individual hardware circuits, using software programs and data, in conjunction with a suitably programmed digital microprocessor or general purpose computer, using application specific integrated circuitry (ASIC), and/or using one or more digital signal processors (DSPs).

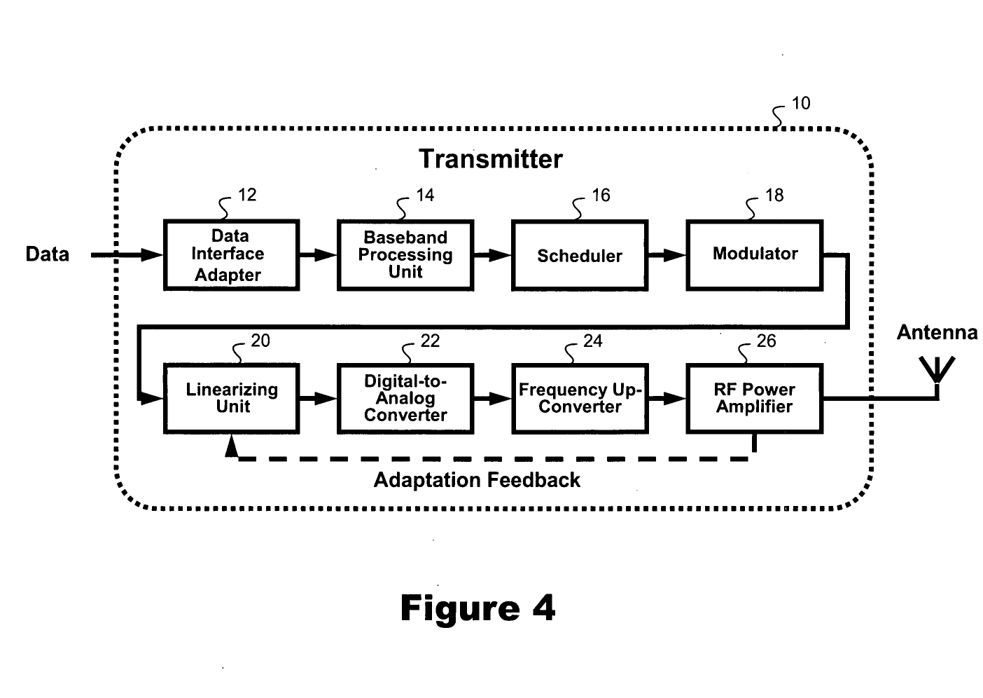

The RF power distribution over frequency technology will now be described in the context of a radio transmitter 10 shown in FIG. 4. Transmitter 10 includes a data interface unit 12 that receives data to be transmitted. The data interface unit 12 converts the data to a format suitable for further processing and passes the converted data to a baseband processing unit 14. The baseband processing unit 14 prepares the data for transmission, by for example performing encrypting of the data, block coding of the data, interleaving of the data, etc, and then forwards the data to a scheduler 16. The scheduler 16 subdivides the baseband data into one or more blocks of data, where all the data to be transmitted at the same power level during a transmission time interval is gathered in the same block. Similar power levels may also be lumped together in the same block to decrease processing load. The amount of data to transmit during one transmission time interval may or may not exhaust the available bandwidth.

The scheduler 16 further subdivides each block of data into data portions, where each portion is associated with one or more consecutive subcarriers within the available bandwidth. The portions may or may not be of equal size. In a simple case, there would be a single data block for transmission at a single power level, although the RF power distribution technology also applies to two or more blocks of data to be transmitted at different power levels. In the preferred non-limiting example embodiment, the scheduler 16 distributes portions of all the blocks in the frequency domain so that transmissions of the portions at each of the power levels are distributed with higher power levels more towards the center of the available frequency bandwidth than lower power levels during the transmission time interval. In a less preferred non-limiting example embodiment, the scheduler 16 substantially evenly distributes portions of all the blocks in the frequency domain over the available frequency bandwidth. The terms available frequency bandwidth and determined frequency bandwidth mean any frequency bandwidth that can be used for transmission by the transmitter or that is determined or decided for use by the transmitter. For example, if an OFDM transmitter is permitted to transmit over ten subcarriers, but a decision is made to transmit only using nine of those subcarriers, then the available or determined frequency bandwidth is those nine subcarriers.

The scheduled data portions are modulated in a modulator 18, and the modulated data portions are then processed in a linearizing unit 20. Although linearizing is preferably used, it is not required for use of the RF power distribution technology. One non-limiting example is the digital linearization circuit described in commonly-assigned U.S. 2004/0247042 A1. The output signal from the linearizing unit 20 is then converted into an analog signal in a digital-to-analog converter 22. A frequency up-converter 24 translates the baseband signal to RF and provides the RF signal to an RF power amplifier 26. The power amplifier 26 amplifies the RF signal, carrying the distributed data block portions, for transmission via the antenna. A portion of the output signal from the power amplifier 26 may optionally be analog-to-digital converted and fed back in an adaptation feedback loop to the linearizing unit 20 to cope with the fact that the distortion caused by the power amplifier 26 may change over time. The feedback loop allows the linearizing unit 20 to track and adapt to changes in the transfer characteristic of the RF power amplifier 26. Although the non-limiting example in FIG. 4 shows the linearizing entity as a separate block in the digital parts of the transmitter, the linearizing function could in other non-limiting examples be performed in the analog parts of the transmitter, or partly in the digital parts and partly in the analog parts of the transmitter.

The transmitter 10 may be used in any suitable transmission application. One non-limiting example is a radio base station used in a cellular radio access network. Another non-limiting example is to an access point in a wireless local area network (WLAN). Still another non-limiting example application is in a mobile station. The term “mobile station” is used generally in this case and encompasses any type of user equipment that can communicate over a wireless interface. There are also wirebound applications, such as the non-limiting example of ADSL.

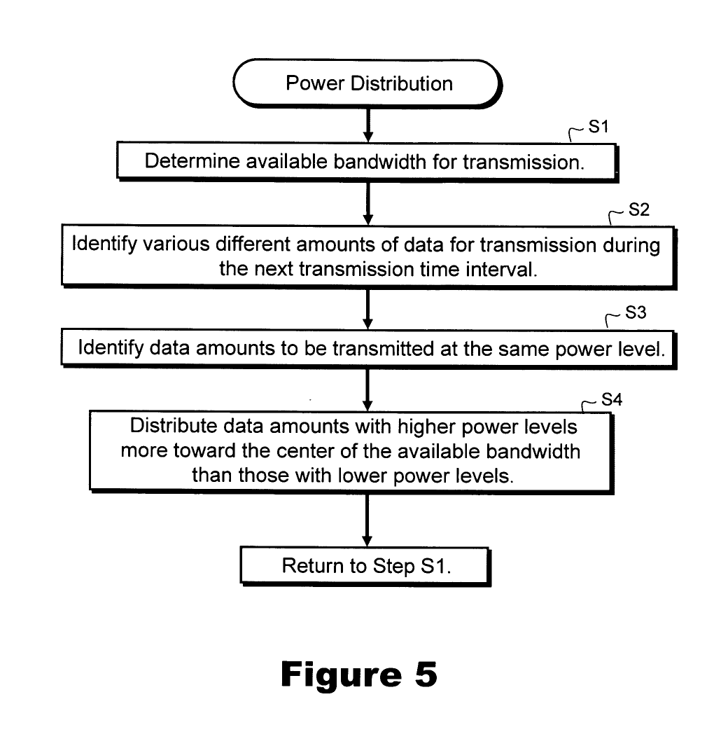

FIG. 5 is a flowchart diagram illustrating non-limiting, example procedures that may be used to implement RF power distribution over frequency. The available bandwidth allocated for transmission by the transmitter is determined (Step S1). Various different amounts of data are identified for transmission during a next transmission time interval to one or more receivers (Step S2). A receiver can be a mobile station, a software application being executed on a computing device, or a particular data flow, e.g., one of many data flows in a multimedia communication. In addition, other parameters that may require or effect transmission resources may optionally also be determined. For example, path loss and certain quality of service parameters, such as a minimum bit rate, maximum bit error rate, etc., would affect the power level needed for data transmission to a particular receiver. Within the data amounts identified for transmission during the next transmission time interval, data amounts to be transmitted with the same or similar power level are identified (Step S3). The data amounts are then preferably—though not necessarily—distributed over frequency with higher power level portions more towards the center of the determined frequency bandwidth than lower power level portions (Step S4). Any type of distribution that in some fashion distributes data amounts with higher power levels more towards the center of the determined frequency bandwidth than data amounts with lower power levels may be used. Indeed, other types of distributions, e.g., substantially even distribution, may be used. Control then returns to Step S1.

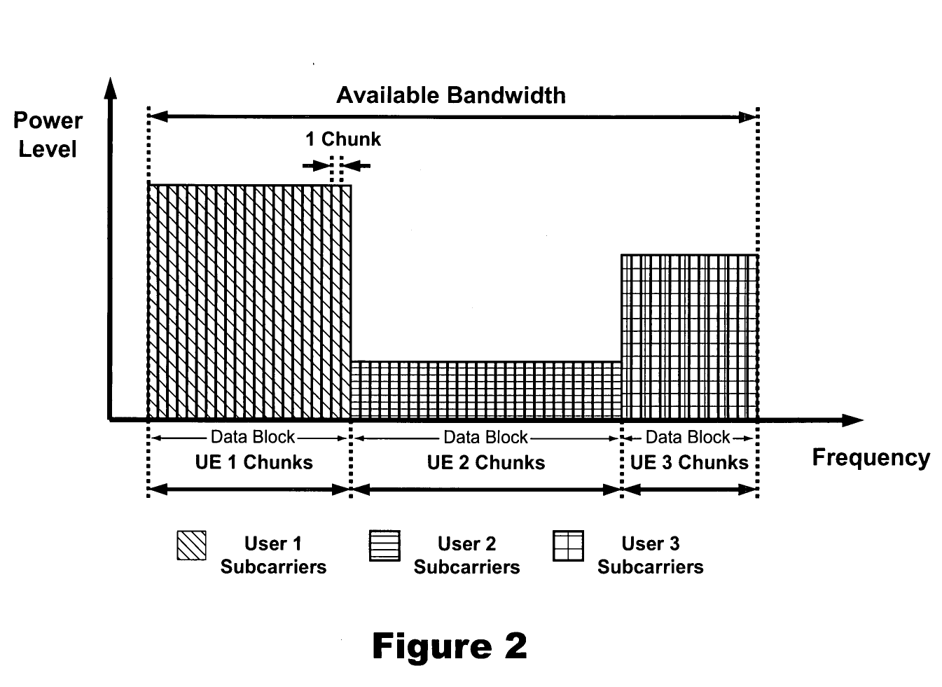

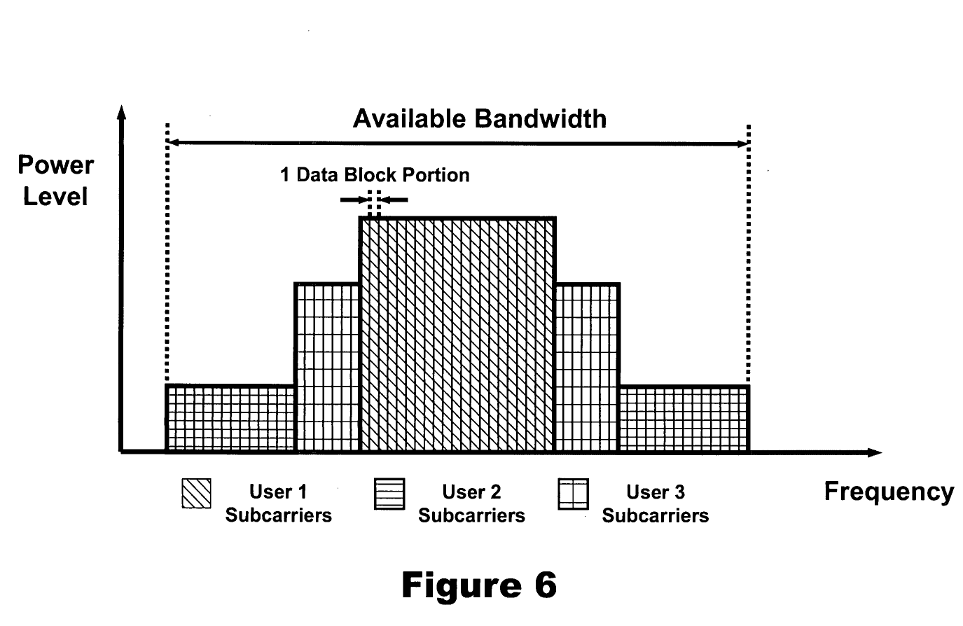

FIG. 6 is a graph of the power level for several users distributed within the available bandwidth in the frequency domain. Compare the distribution in FIG. 6 with the typical type of power distribution used by transmitters used in the non-limiting example of FIG. 2 in which all of the UE1 chunks at power level 1 were grouped together in a single contiguous data block, all of the UE2 chunks power level 2 were contiguously grouped in a data block, and all of the UE3 chunks power level 3 were contiguously grouped in a data block. FIG. 6 shows that those contiguous data blocks have been broken up and distributed within the available bandwidth with higher power levels more towards the center of the determined frequency bandwidth than lower power levels in the resulting power amplifier output.

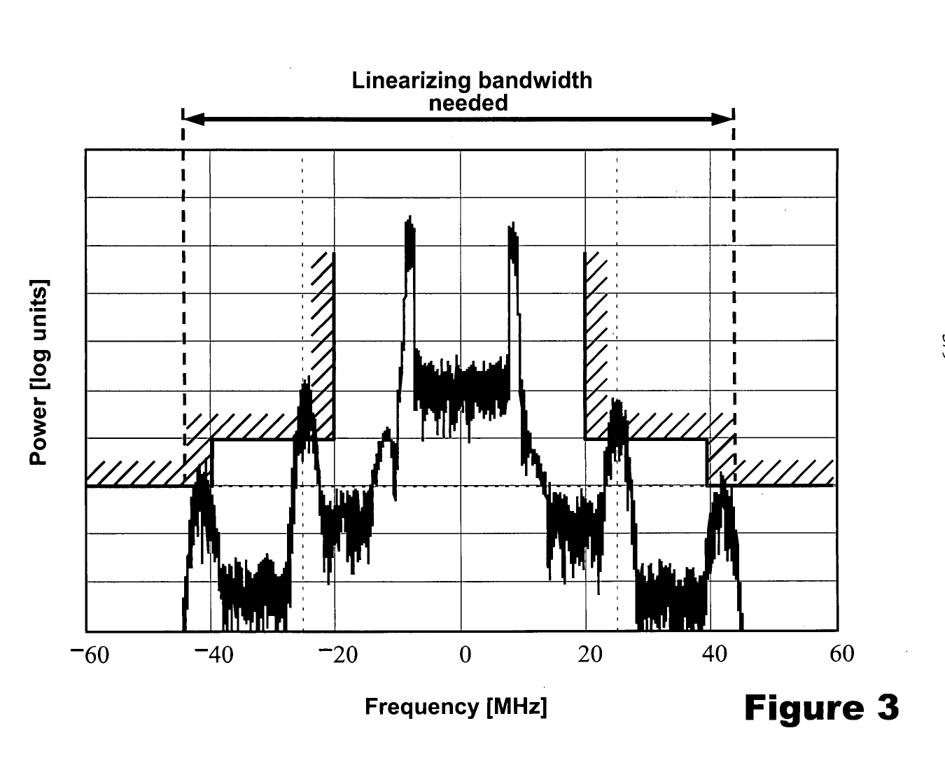

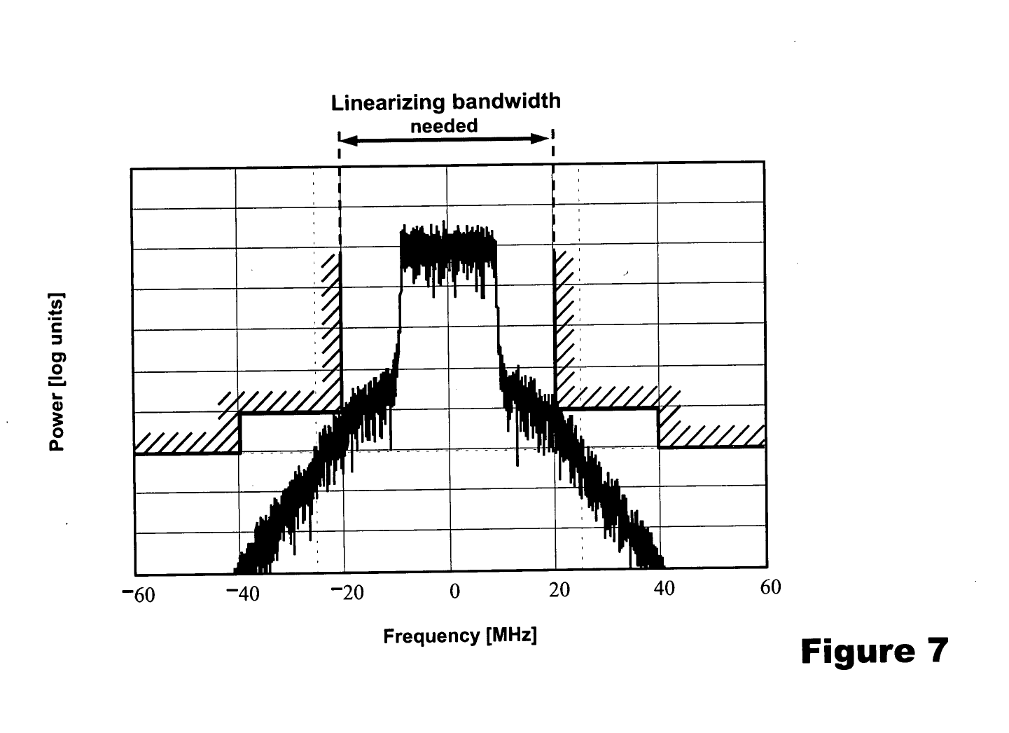

FIG. 7 shows, in contrast to FIG. 3, no out-of-band emissions violations at the locations corresponding to the third and fifth order intermodulation distortions. As compared to the IM suppression capability required in FIG. 3, much less IM suppression capability in a much smaller bandwidth is thus required from the linearizing unit.

There are multiple advantages associated with the RF power distribution over frequency technology. First, lower cost, since a linearizing unit with lower bandwidth and lower out-of-band emission requirements may be employed to adequately linearize the RF power amplifier output. Second, lowering the requirements on the linearizing unit for linearizing the power amplifier also lessens the requirements for the adaptation feedback from the power to the linearizing unit if such feedback is used. Third, better resilience to Rayleigh fading may be obtained, since a power dip caused by Rayleigh fading only affects local parts of the available bandwidth, whereas the power aimed for each UE is spread out.

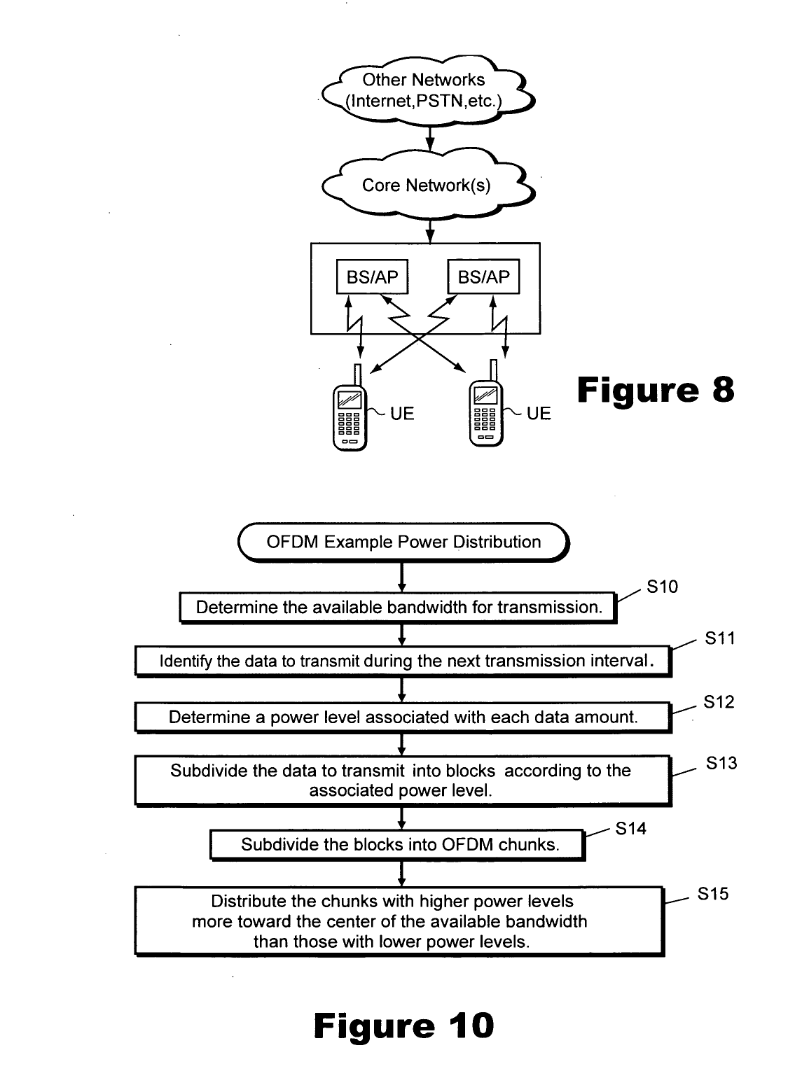

One example environment in which this technology can be used is mobile telecommunications. FIG. 8 shows a simplified mobile telecommunication system in which multiple user equipments (UEs) communicate over a radio interface with a transport network that includes one or more base stations (BS) and/or access points (AP). The transport network is typically connected to one or more core networks which in turn are connected to other networks such as the Internet, the PSTN, etc.

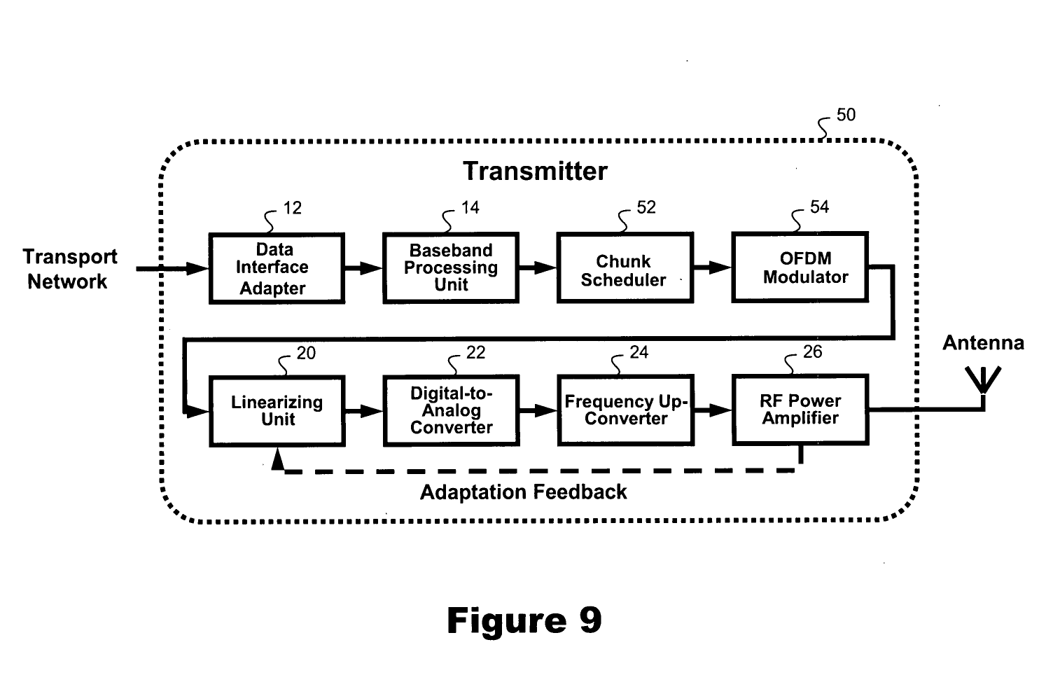

In this mobile communication environment, one non-limiting example application is a radio base station such as that illustrated at 50 in FIG. 9. This diagram is similar to that described in FIG. 4, so only the differences are described here. Data is received in the data interface unit 12 from a transport network, e.g., a radio access network, for downlink transmission to one or several UEs. In this example, OFDM is used, and therefore, the data block scheduler is a chunk scheduler 52. The chunk scheduler 52 is configured to distribute multiple chunks of one or more data blocks to be transmitted, each at its own power level, across the available bandwidth in the frequency domain. The OFDM chunk scheduler 52 then provides the scheduled chunks to an OFDM modulator 54 which modulates each of the subcarriers within the available bandwidth in accordance with the scheduler output and converts the set of subcarriers into a time domain signal. The OFDM modulator output is processed as described with respect to FIG. 4. A mobile station can also use a transmitter like that shown in FIG. 9.

Reference is made to OFDM example power distribution procedures shown in flowchart form in FIG. 10 that may be performed by a radio base station transmitter using OFDM. The available bandwidth for transmission during the transmission time interval is determined (Step S10). Various different amounts of data to be transmitted during a next transmission time interval are identified (Step S11). A power level to use for each of the various parts of the data is determined (Step S12). For example, path loss and certain quality of service parameters, such as a minimum bit rate, maximum bit error rate, etc., would affect the power level needed for data transmission of a particular amount or part of data. The determined data amounts are subdivided into one or more blocks, where each block contains data amounts associated with the same or similar power level (Step S13). Each of the blocks is subdivided into one or more OFDM chunks, each OFDM chunk corresponding to one or more consecutive subcarriers within the available bandwidth (Step S14). The OFDM chunks are then distributed over frequency so that OFDM chunks are distributed with higher power levels more towards the center of the available frequency bandwidth than OFDM chunks with lower power levels (Step S15). If the receiving bandwidth of a particular mobile station is limited to a subset of the transmitter's available bandwidth, then the OFDM chunks to be transmitted to that mobile must be distributed with higher power levels more towards the center of the transmitter's available frequency bandwidth than lower power levels, but within that mobile's receiving bandwidth only.

One non-limiting example power level distributing across frequency algorithm for the above OFDM example is now described. The OFDM chunks are sorted according to their corresponding power levels from high to low power level. The OFDM chunks are then allocated in order of power level, starting from the highest power level, from the center of the available bandwidth and contiguously outward so that every second chunk is allocated at the next lower frequency space and each of the remaining chunks is allocated at the next higher frequency space. When the algorithm is finished, the OFDM chunks with higher power levels occur more toward the center of the available bandwidth than the chunks with lower power level.

Although various embodiments have been shown and described in detail, the claims are not limited to any particular embodiment or example. None of the above description should be read as implying that any particular element, step, range, or function is essential such that it must be included in the claims scope. The scope of patented subject matter is defined only by the claims. The extent of legal protection is defined by the words recited in the allowed claims and their equivalents. No claim is intended to invoke paragraph 6 of 35 USC §112 unless the words “means for” are used.

1. A transmitter for transmitting data using a determined frequency bandwidth during a transmission time interval, comprising:
processing circuitry configured to perform the following:
identify a block of data to be transmitted at a chosen power level during the transmission time interval; and
distribute multiple portions of the data block for transmission at different frequencies so that transmissions at the chosen power level are distributed within the determined frequency bandwidth;
a power amplifier for amplifying a radio frequency signal carrying the distributed data block portions; and
a power amplifier output port for transmitting the amplified signal over a communications interface.

2. The transmitter in claim 1, wherein the data block portion distribution reduces a peak power of intermodulation products which are caused by the radio frequency signal being distorted by non-linearities in the transfer function of the power amplifier.

3. The transmitter in claim 1, wherein the data block portion distribution reduces a power outside the determined frequency bandwidth of intermodulation products which are caused by the radio frequency signal being distorted by non-linearities in the transfer function of the power amplifier.

4. The transmitter in claim 1, wherein the processing circuitry is configured to substantially distribute multiple portions of the data block within the determined frequency bandwidth so that portions with higher power levels are distributed more towards the center of the determined frequency bandwidth than portions with lower power levels.

5. The transmitter in claim 1, wherein the processing circuitry is configured to substantially evenly distribute multiple portions of the data block across the determined frequency bandwidth.

6. The transmitter in claim 1, wherein the processing circuitry is configured to perform the following:
identify two or more blocks of data to be transmitted, each at a different power level, during the transmission time interval, and
distribute multiple portions of the two or more data blocks for transmission at different frequencies so that transmissions at the different power levels are distributed within the determined frequency bandwidth.

7. The transmitter in claim 6, wherein the processing circuitry is configured to substantially distribute multiple portions of the data block within the determined frequency bandwidth so that portions with higher power levels are distributed more towards the center of the determined frequency bandwidth than portions with lower power levels.

8. The transmitter in claim 1, further comprising:
linearizing circuitry for linearizing the power amplifier's output signal containing the distributed data block portions.

9. The transmitter in claim 8, further comprising:
a feedback path from the power amplifier to the linearizing circuitry for regulating the linearizing circuitry.

10. The transmitter in claim 1 used in a radio base station or access point.

11. The transmitter in claim 1 used in a mobile radio station.

12. The transmitter in claim 1, wherein the data blocks may be of the same or different sizes.

13. The transmitter in claim 1, wherein the transmitter is used for orthogonal frequency division multiplexing (OFDM) and each of the data blocks includes one or more OFDM data chunks, each chunk corresponding to a range of consecutive OFDM subcarriers, and the processing circuitry is configured to distribute all chunks of all data blocks for all power levels over the OFDM subcarriers constituting the determined bandwidth in a non-overlapping way such that, for all power levels, all chunks within each power level are substantially evenly distributed or spread out within the determined bandwidth.

14. The transmitter in claim 11 wherein the processing circuitry includes an OFDM data chunk scheduler and an OFDM modulator.

15. A method for transmitting data using an available frequency bandwidth during a transmission time interval, comprising:
identifying a block of data to be transmitted at a chosen power level during the transmission time interval;
distributing multiple portions of the data block for transmission at different frequencies so that transmissions at the chosen power level are distributed within the available frequency bandwidth;
power amplifying a radio frequency signal carrying the distributed data block portions; and
transmitting the amplified signal over a communications interface.

16. The method in claim 15, wherein the data block portion distribution reduces a peak power of intermodulation products caused by the radio frequency signal being distorted by non-linearities in the transfer function of the power amplification.

17. The method in claim 15, wherein the data block portion distribution reduces a power outside the determined frequency bandwidth of intermodulation products which are caused by the radio frequency signal being distorted by non-linearities in a transfer function of the power amplifier.

18. The method in claim 15, wherein the distributing includes substantially distribute multiple portions of the data block within the determined frequency bandwidth so that portions with higher power levels are distributed more towards the center of the determined frequency bandwidth than portions with lower power levels.

19. The method in claim 15, wherein the distributing includes substantially evenly distributing multiple portions of the data block across the available frequency bandwidth.

20. The method in claim 15, further comprising:
identifying two or more blocks of data to be transmitted, each at a different power level, during the transmission time interval, and
distributing multiple portions of the two or more data blocks for transmission at different frequencies within the available frequency bandwidth so that transmissions at the different power levels are distributed across the available frequency bandwidth.

21. The method in claim 20, wherein the distributing includes distributing multiple portions of the data block within the determined frequency bandwidth so that portions with higher power levels are distributed more towards the center of the determined frequency bandwidth than portions with lower power levels.

22. The method in claim 15, further comprising:
linearizing of the power amplified signal containing the distributed data block portions.

23. The method in claim 22, further comprising:
providing a feedback signal associated with the amplified signal for regulating the linearizing.

24. The method in claim 15 implemented in a radio base station or access point.

25. The method in claim 15 implemented in a mobile radio station.

26. The method in claim 15, wherein the data blocks may be of the same or different sizes.

27. The method in claim 15, wherein the transmission uses orthogonal frequency division multiplexing (OFDM) and the data blocks include one or more OFDM data chunks, each OFDM chunk including multiple, consecutive subcarriers, and the method further comprising:
distributing multiple chunks of the first OFDM data block for transmission at different subcarriers so that transmissions at the first power level are distributed across the available frequency bandwidth, and
distributing multiple chunks of the second OFDM data block for transmission at different subcarriers so that transmissions at the second power level are distributed across the available frequency bandwidth.

28. The method in claim 27, further comprising:
scheduling the OFDM data chunks for transmission, and
OFDM modulating the scheduled OFDM data chunks.
